(19) United States
(12) Patent Application Publication
(10) Pub. No.: US 2014/0168818 A1
(43) Pub. Date: Jun. 19, 2014

(54) READ SENSOR FOR RECORDING HEAD

(71) Applicant: SEAGATE TECHNOLOGY LLC, Cupertino, CO (US)

(72) Inventors: Victor Boris Sapozhnikov, Minnetonka, MN (US); Scott Wilson Stokes, Maple Grove, MN (US); Jae-Young Yi, Prior Lake, MN (US); Mohammed Shariat Ullah Patwari, Eden Prairie, MN (US); Yonghua Chen, Bloomington, MN (US)

(73) Assignee: SEAGATE TECHNOLOGY LLC, Cupertino, CO (US)

(21) Appl. No.: 13/720,712

(22) Filed: Dec. 19, 2012

(51) Int. Cl. G11B 5/147

(52) U.S. Cl. CPC G11B 5/147
USPC 360/235.4; 360/313

(57) ABSTRACT

Implementations described and claimed herein provide a read sensor structure having a synthetic anti-ferromagnetic (SAF) structure with a pinning that is canted with respect to an air bearing surface (ABS) of the read sensor. In an implementation of the read sensor, the angle between the pinning direction of a reference layer (RL) and the pinning direction of a free layer (FL) is obtuse.

### BACKGROUND

In a magnetic data storage and retrieval system, a magnetic read/write head typically includes a reader portion having a magnetoresistive (MR) sensor for retrieving magnetically encoded information stored on a magnetic disc. Magnetic flux from the surface of the disc causes rotation of the magnetization vector of a sensing layer of the MR sensor, which in turn causes a change in electrical resistivity of the MR sensor. The change in resistivity of the MR sensor can be detected by passing a current through the MR sensor and measuring a voltage across the MR sensor. External circuitry then converts the voltage information into an appropriate format and manipulates that information as necessary to recover the information encoded on the disc.

### SUMMARY

Implementations described and claimed herein provide a read sensor having a reference layer (RL) with a magnetic moment direction canted in comparison to direction of a magnetic moment of a free layer (FL) at an angle other than 90 degrees. In an implementation of the read sensor, an angle between the magnetic moment direction of the RL and the direction of the magnetic moment of the FL is obtuse.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. These and various other features and advantages will be apparent from a reading of the following detailed description.

### BRIEF DESCRIPTIONS OF THE DRAWINGS

FIG. 1 illustrates an example block diagram illustrating an example read sensor structure implemented on an end of an actuator assembly.

FIG. 2 illustrates an example graph of the relationship between resistance-based signal amplitude and an angle between free layer-reference layer magnetization.

FIG. 3 illustrates a graph illustrating a relationship of a resistance-based signal as a function of the pinning angle.

FIG. 4 illustrates a graph illustrating a relationship between reader magnetization asymmetry as a function of the pinning angle.

FIG. 5 illustrates a graph illustrating a relationship between reference layer angle amplitude and the pinning angle.

FIG. 6 illustrates an example canted pinning design of the reference layer.

FIG. 7 illustrates an example graph illustrating relationship between magnetization amplitude and a quiescent angle between free layer-reference layer magnetization for the read sensor disclosed herein.

FIG. 8 illustrates a plan view of an example disc drive using the read sensor disclosed herein.

### DETAILED DESCRIPTIONS

Magnetic disk drives typically include a rotating magnetic disk, a slider that has read and write heads, a suspension arm above the rotating disk and an actuator arm that swings the suspension arm to place the read and write heads over selected circular tracks on the rotating disk. The suspension arm biases the slider into contact with the surface of the disk when the disk is not rotating but, when the disk rotates, air is swirled by the rotating disk adjacent an air bearing surface (ABS) of the slider causing the slider to ride on an air bearing a slight distance from the surface of the rotating disk. When the slider rides on the air bearing the write and read heads are employed for writing magnetic impressions to and reading magnetic signal fields from the rotating disk. The read and write heads are connected to processing circuitry that operates according to a computer program to implement the writing and reading functions.

Magnetoresistive (MR) read sensors, commonly referred to as MR heads, are used in all high capacity disk drives. An MR sensor detects a magnetic field through the change in its resistance of as a function of the strength and direction of the magnetic flux being sensed by the MR layer. The standard type of MR sensor in disk drives manufactured today employs the tunneling magnetoresistive (TMR) effect, such that the resistance varies as a function of the spin-dependent quantum-mechanical tunneling transmission of the conduction electrons between two or more ferromagnetic layers separated by an insulating, non-magnetic tunneling barrier. The resistance of these sensors depends on the relative orientation of the magnetization of the different magnetic layers.

An MR read sensor may include a number of magnetic layers, such as an antiferromagnetic (AFM) layer, a synthetic antiferromagnetic (SAF) layer, and a free layer (FL). The SAF and the FL may be separated by a tunneling barrier and the SAF layer may include a pinned layer (PL) and a reference layer (RL) separated by a Ruthenium (Ru) layer. The PL is pinned such that the moment of the magnetization of the PL is perpendicular to an air-bearing surface (ABS) of the read sensor. Similarly, the RL is pinned such that the moment of the magnetization of the RL is also perpendicular to the ABS. However, the direction of the magnetization of the RL and the PL are opposite, or 180 degrees apart from each other.

On the other hand, the FL is biased such that the moment of magnetization of the FL is at 90 degrees from the pinning of the PL and RL. In other words the direction of the magnetization of the FL is in a direction parallel to the surface of the ABS. Specifically, the direction of the magnetization of the FL is generally in a direction parallel to the surface of the ABS and in the cross-track direction in a direction perpendicular to the movement of the read sensor over the magnetized media. The direction of the magnetic moment of the RL and the direction of the magnetic moment of the FL rotate in opposite directions during a change in magnetic field from a medium. Specifically, during the operation of the read sensor, the sensor is exposed to a range of magnetic fields from the recording medium, from positive to negative fields. As the field changes, the direction of the magnetic moments of the various magnetic layers of the stack rotates, thus creating a signal.

As the read sensor moves on the surface of the magnetic recording media, the pinning of the PL generally stays at substantially close to 90 degrees to the ABS of the read sensor. However, depending on the magnetization of the magnetic recording media, the magnetization of the FL changes, thus changing the angle between the magnetization of the RL and the FL, which produces a signal in proportion to the tunneling magnetoresistance (TMR) generated by the recording media. The read sensor is positioned between biasing structures, such as permanent magnets (PM) such that the PM pushes the pinning of the RL and the PL in the opposite direction and is aimed at balancing it to be at 90 degrees to the ABS. One function of the RL is to balance the pinning of the FL to be parallel to the ABS while another function of the RL is to ensure that the pinning of the SAF remains at 90 degrees to the ABS and that it does not tilt. However, these two functions of the RL are contradictory to each other. Furthermore, the RL and the FL are coupled to each other by orange peel coupling, which tilts the pinning of the RL towards the FL.

The thicknesses and magnetic moments of the SAF layers, specifically the PL layer and the RL layer, are selected such that the magnetization of the SAF layer pushes the biasing of the FL parallel to the ABS. However, this objective of keeping the pinning of the FL parallel to the ABS results in tilting of the magnetization of the RL such that it is not perpendicular to the ABS.

In one implementation of the read sensor disclosed herein, the pinning direction of the RL is canted compared to the perpendicular to the magnetization direction of the FL. Specifically, in one alternative implementation, the angle between the pinning direction of the RL and the magnetization direction of the FL is obtuse.

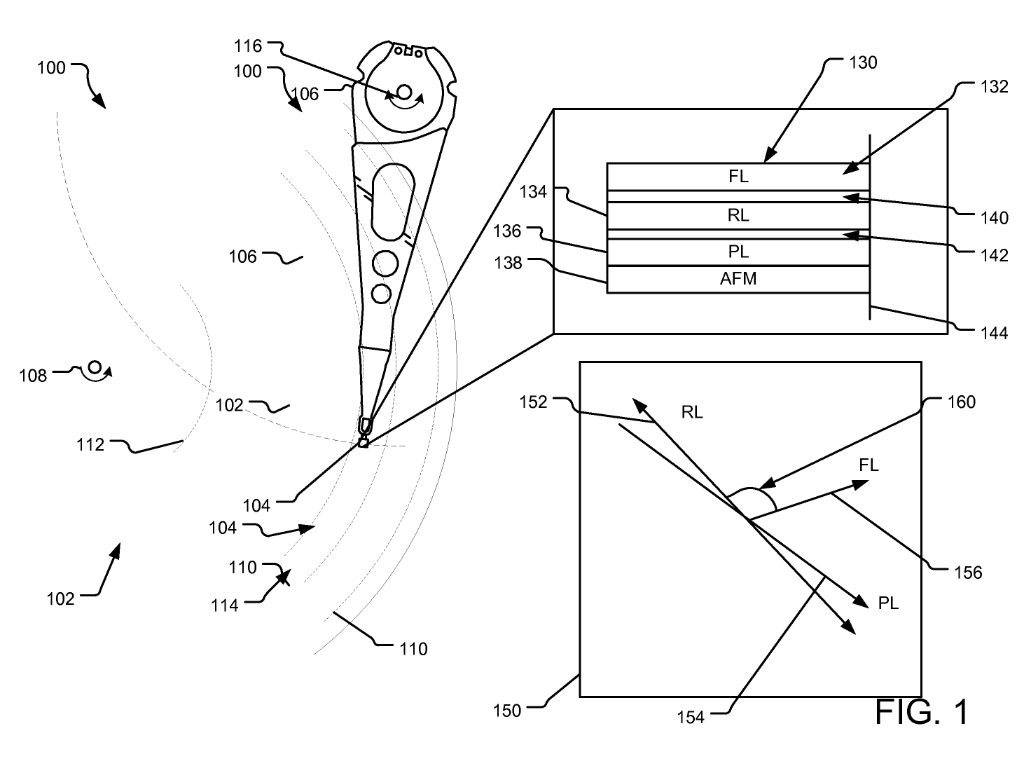

FIG. 1 illustrates an example block diagram illustrating an example read sensor structure implemented on an end of an actuator assembly. Specifically, FIG. 1 illustrates a plan view of an implementation of a disc 102 with a transducer head 104 situated on an end of an actuator assembly 106. Disc 102 rotates about a disc axis of rotation 108 during operation. Further, disc 102 includes an outer diameter 110 and inner diameter 112 between which are a number of data tracks 114, illustrated by circular dotted lines. Data tracks 114 are substantially circular and are made up of regularly spaced patterned bits.

Information may be written to and read from the patterned bits on the data tracks 114 through the use of the actuator assembly 106, which rotates during a data track 114 seek operation about an actuator axis of rotation 116 positioned adjacent the disc 102. The transducer head 104 mounted on the actuator assembly 106 at an end distal from the actuator axis of rotation 116 flies in close proximity above the surface of the disc 102 during disc operation. The transducer head 104 includes recording head including a read sensor for reading data from the track 114 and a write pole for writing data to the track 114.

To read data from the magnetic disk 102, transitions on the track 114 of the disk 102 creates magnetic fields. As the read sensor passes over the transitions, the magnetic fields of the transitions modulate the resistance of the read sensor. The change in the resistance of the read sensor is detected by passing a sense current through the read sensor and then measuring the change in voltage across the read sensor. The resulting resistance-based signal is used to recover data encoded on the track of the disk 102.

FIG. 1 also illustrates an expanded view of a partial cross-sectional configuration of a read sensor 130 wherein the read sensor may be located on the transducer head 104. The read sensor 130 is shown to include an FL 132 located at the top of the read sensor 130. The FL 132 is separated from an RL 134 by a tunneling barrier 140. The RL 134 is located on tope of a PL 136 and separated from the PL 136 by a Ruthenium (Ru) layer 142. The bottom of the read sensor 130 includes an AFM layer 138. The combination of the RL 134, the PL 136 and the Ru layer 142 is also referred to as the SAF structure. Various layers of the read sensor 130 are disclosed with respect to an ABS layer 144 of the read sensor 130.

The read sensor 130 also illustrates a graphical representation 150 of the pinning of various layers with respect to the ABS 144. Specifically, as shown in FIG. 1, the biasing 152 of the magnetization of the RL and the pinning 154 of the PL are generally in opposite direction. The biasing 156 of the magnetization of the FL is such that the angle 160 between the biasing 156 of the magnetization of the FL and the biasing 152 of the magnetization of the RL is obtuse. For example, in one implementation, the angle 160 is greater than 105 degrees. Providing the magnetization biasing of the RL and FL such that the angle 160 is obtuse allows the read sensor 130 to increase the amplitude of the resistance-based signal generated by the read sensor 130. Specifically, because the resistance-based signal is not symmetric with respect to the 90 degree angle for the FL-RL biasing, the maximum amplitude of the resistance-based signal is achieved at an obtuse angle between the FL-RL biasing.

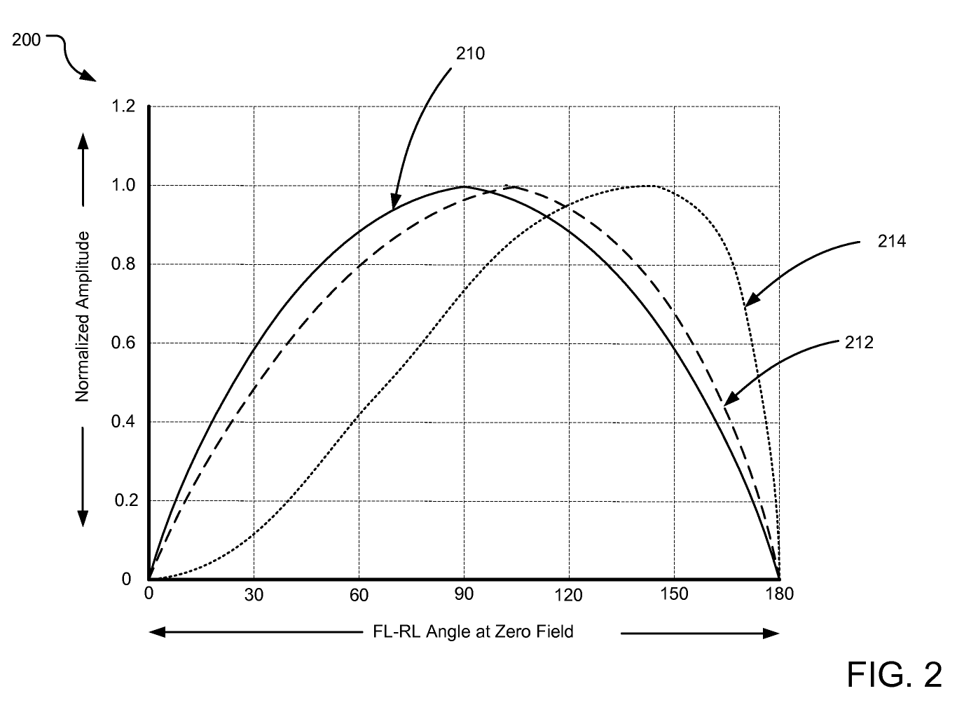

FIG. 2 illustrates an example graph 200 of the relationship between the resistance-based signal amplitude and an angle between FL-RL magnetization. Specifically, the graph 200 illustrates the relationship between the resistance-based signal amplitude and an angle between FL-RL magnetization at various levels of tunneling magneto-resistance (TMR). The TMR is calculated based on the sensor resistance value when the magnetizations of FL and RL are parallel and the sensor resistance value when the magnetizations of FL and RL are anti-parallel. Specifically, TMR=(Rₐₙₜᵢₚₐᵣₐₗₗₑₗ−Rₚₐᵣₐₗₗₑₗ)/Rₚₐᵣₐₗₗₑₗ. Referring to FIG. 2, a line 210 illustrates such relationship when the TMR is at zero (0) percent, a line 212 illustrates such relationship when the TMR is at one hundred (100) percent, and a line 214 illustrates such relationship when the TMR is at one thousand (1000) percent.

As illustrated in FIG. 2, while for zero percent TMR the resistance-based signal amplitude peaks at 90 degrees angle between FL-RL magnetization, this is not the case for TMR greater than zero percent. For example, for TMR of 100 percent, the resistance-based signal is not symmetric with respect to the 90 degrees angle between FL-RL biasing. In this case, the resistance-based signal is right skewed and it peaks at an angle higher than 90 degrees. Such angle, where the amplitude-based signal substantially at its maximum, depends on the TMR value. Specifically, the resistance R of the read sensor as a function of the TMR, and the FL-RL angle theta (θ) can be given by the equation I below:

R=R_{∥}((1+TMR)/(1+0.5TMR(1+cos(θ)))) I

Here R_{∥} is the resistance of the read sensor when the FL is parallel to the RL.

By providing an obtuse RL-FL pinning angle, the read sensor disclosed herein allows maximizing the amplitude of the resistance-based signal.

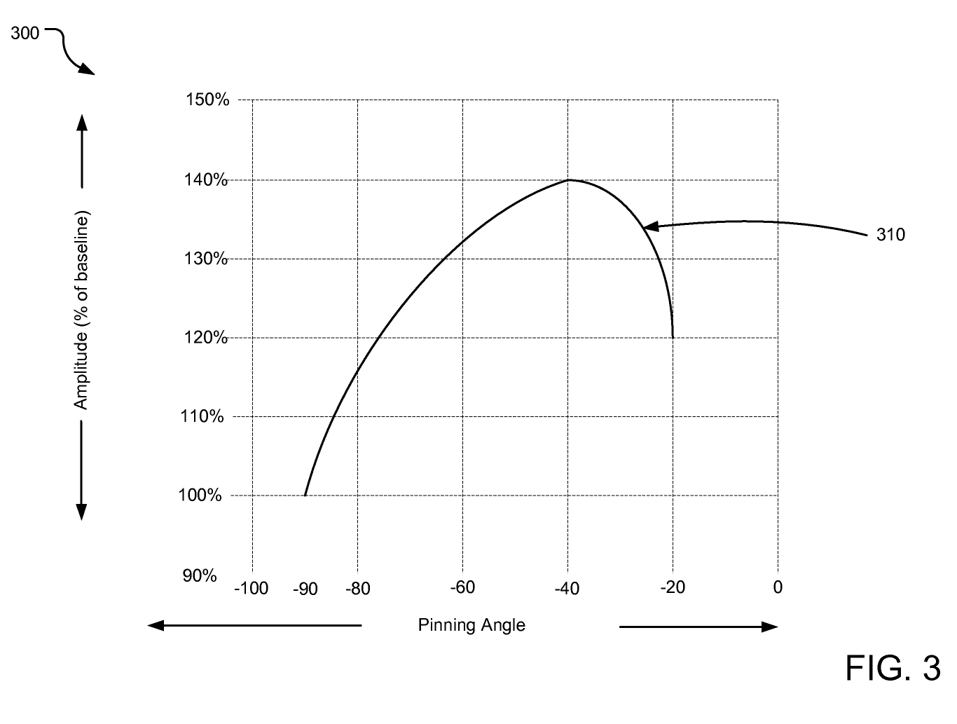

FIG. 3 illustrates a graph 300 illustrating a relationship 310 between the resistance-based signal amplitude as a function of the pinning angle of the SAF with respect to the ABS. Specifically, FIG. 3 illustrates that if the resistance-based signal amplitude were based at 100% when the pinning angle of the SAF is 90 degrees to the ABS, by canting the pinning angle of the SAF to the ABS, the amplitude is increased. For example, for the pinning angle of the SAF to the ABS being in the range of −40 degrees, the resistance-based signal amplitude is maximized substantially, generally by up to forty percent.

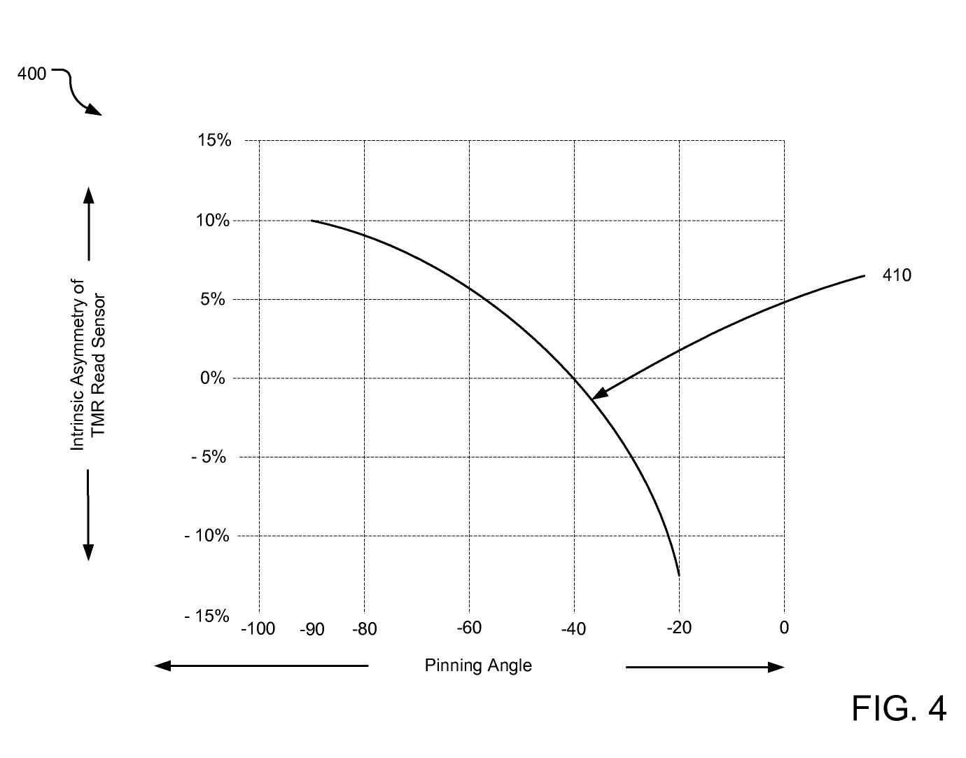

FIG. 4 illustrates a graph 400 illustrating a relationship 410 between asymmetry of a TMR read sensor as a function of the pinning angle of the SAF with respect to the ABS. Here the asymmetry of the TMR is the asymmetry between the reader voltage V+ at the highest positive magnetic field and the V− at the highest negative magnetic field, given the V0 as the reader voltage at zero magnetic field. Current magnetic recording devices with high areal density also have high TMR ratio.

FIG. 4 illustrates that if the asymmetry of the TMR sensor is about 10% when the pinning angle of the SAF to the ABS is about 90 degrees, by provided canted pinning, the asymmetry can be substantially reduced. For example, when the pinning angle of the SAF to the ABS is canted by about 40 degrees, the intrinsic asymmetry reduces by as much as ten percent. Furthermore, it is also possible to achieve substantially zero, or close to zero, intrinsic asymmetry. The ability to use the pinning angle of the SAF to the ABS to control the intrinsic asymmetry of the read sensor allows to achieve a balanced SAF structure, will not cant in the PM field. Specifically, this is achieved due to the thicknesses and moments of PL and RL such that the PL and RL torques cancel each other out. By achieving such asymmetry by managing the pinning angle, it is possible to have the balanced SAF structure. Furthermore, such ability to use the pinning and of the SAF to the ABS to control the intrinsic asymmetry of the read sensor also allows compensating for the coupling between the FL and the RL. For example, a thinner tunneling barrier may be used with a lower resistance area (RA) that provides a higher level of coupling between the FL and the RL. Such thinner tunneling barrier also results in reduction of tunneling barrier RA. Alternatively, this opens a way to using high moment FL materials that are known to provide higher coupling between the FL and the RL (e.g., CoFe).

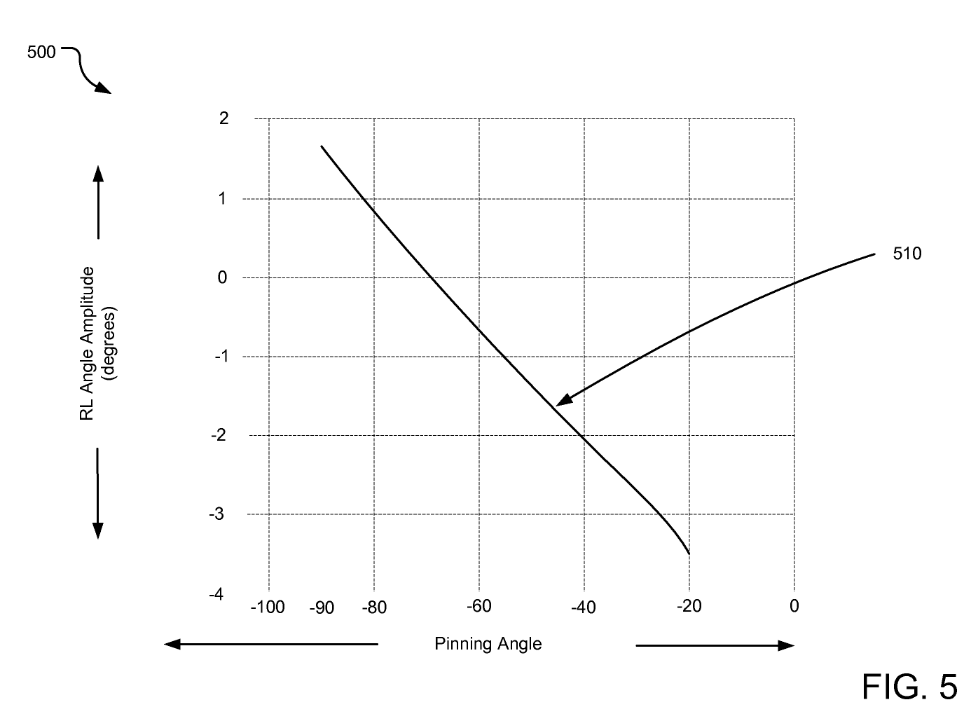

FIG. 5 illustrates a graph 500 illustrating a relationship 510 between RL angle rotation amplitude and the pinning angle of the SAF to the ABS. Specifically, the graph 500 illustrates that canting the pinning angle of the SAF to the ABS from the baseline of −90 degrees to another angles reduces the RL pinning angle rotation. For example, when the pinning angle of the SAF to the ABS from the baseline of −90 degrees to −70 degrees reduces the RL pinning angle rotation substantially to zero.

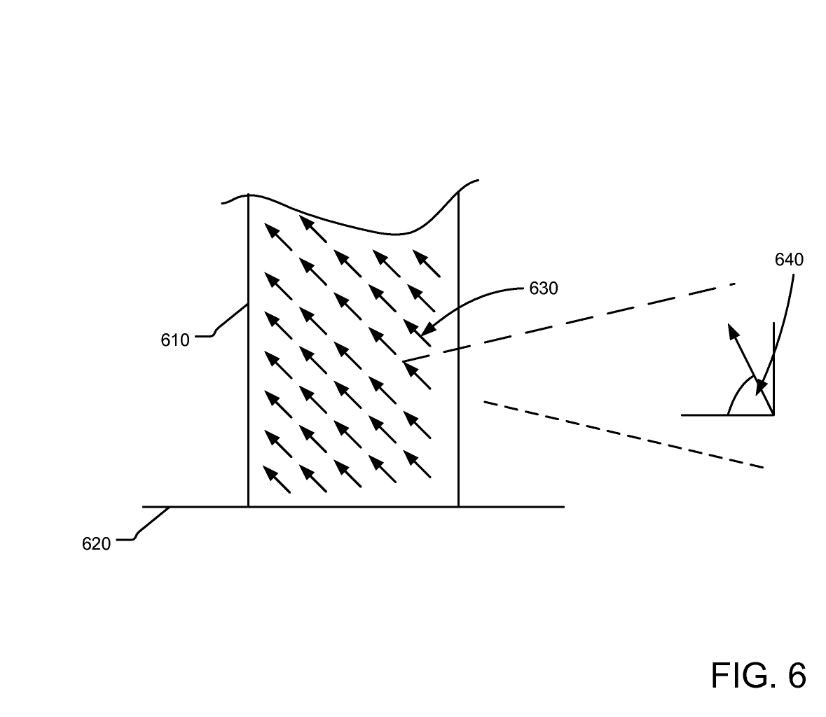

FIG. 6 illustrates the magnetization of a reference layer (RL) 610 in the canted pining design disclosed herein. Specifically, as illustrated in FIG. 6, the magnetization 630 of the RL 610 is canted at an angle to an ABS 620 wherein the angle of magnetization 640 is other than 90 degrees.

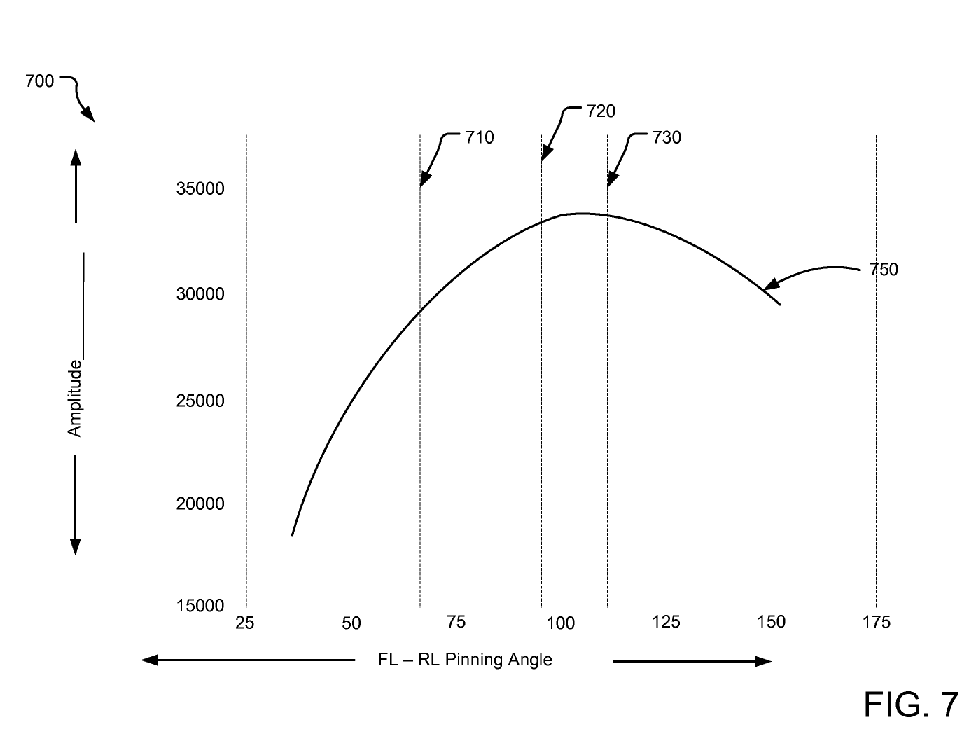

FIG. 7 illustrates an example graph 700 illustrating relationship between resistance-based signal amplitude and a quiescent angle between FL-RL magnetization for a read sensor disclosed herein. Specifically, the graph 700 illustrates results of experiments where read sensor structures with three difference angles between a magnetization direction of an FL and a magnetization direction of an RL were fabricated. The design of the read sensor structure was identical in other aspects. However, the annealing direction that sets the exchange bias direction was changed for each experiment. Three different annealing angles were chosen: namely, −90 degrees, −55 degrees, and −40 degrees. Because the pinning directions in small read sensors may vary around an anneal direction, the dashed vertical lines 710, 720, and 730 represent the mean angle between the magnetization direction of an RL and the magnetization direction of an FL. The resulting resistance-based signal amplitude line 750 suggests that by changing the angle between the magnetization direction of an RL and the magnetization direction of an FL from the baseline of −90 degrees to −40 degrees, the resistance-based signal amplitude increases from around 30000 nV to around 37000 nV.

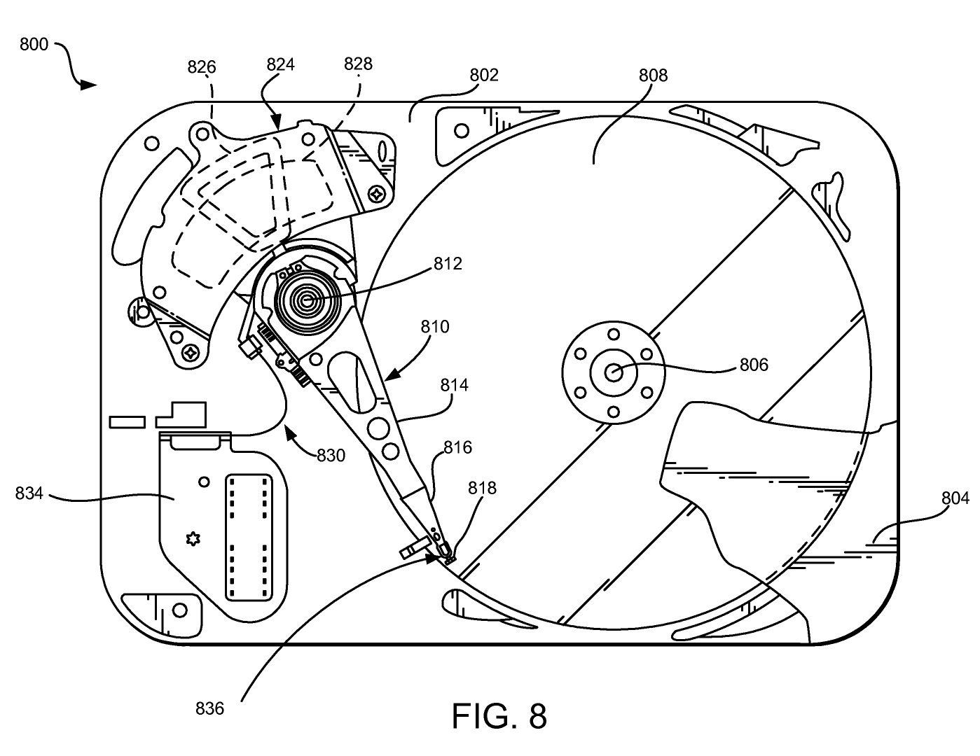

FIG. 8 illustrates a plan view of an example disc drive 800 that may use the read sensor disclosed herein with magnetization direction of the RL canted in comparison to magnetization of the FL. The disc drive 800 includes a base 802 to which various components of the disc drive 800 are mounted. A top cover 804, shown partially cut away, cooperates with the base 802 to form an internal, sealed environment for the disc drive in a conventional manner. The components include a spindle motor 806 that rotates one or more storage medium discs 808 at a constant high speed. Information is written to and read from tracks on the discs 808 through the use of an actuator assembly 810, which rotates during a seek operation about a bearing shaft assembly 812 positioned adjacent the discs 808. The actuator assembly 810 includes a plurality of actuator arms 814 that extend towards the discs 808, with one or more flexures 816 extending from each of the actuator arms 814. Mounted at the distal end of each of the flexures 816 is a head 818 that includes an air bearing slider enabling the head 818 to fly in close proximity above the corresponding surface of the associated disc 808. The distance between the head 818 and the storage media surface during flight is referred to as the “fly height”.

During a seek operation, the track position of the head 818 is controlled through the use of a voice coil motor (VCM) 824, which typically includes a coil 826 attached to the actuator assembly 810, as well as one or more permanent magnets 828 which establish a magnetic field in which the coil 826 is immersed. The controlled application of current to the coil 826 causes magnetic interaction between the permanent magnets 828 and the coil 826 so that the coil 826 moves in accordance with the well-known Lorentz relationship. As the coil 826 moves, the actuator assembly 810 pivots about the bearing shaft assembly 812, and the transducer heads 818 are caused to move across the surfaces of the discs 808.

The spindle motor 806 is typically de-energized when the disc drive 800 is not in use for extended periods of time. The transducer heads 818 are moved away from portions of the disk 808 containing data when the drive motor is de-energized. The transducer heads 818 are secured over portions of the disk not containing data through the use of an actuator latch arrangement and/or ramp assembly 844, which prevents inadvertent rotation of the actuator assembly 810 when the drive discs 808 are not spinning.

A flex assembly 830 provides the requisite electrical connection paths for the actuator assembly 810 while allowing pivotal movement of the actuator assembly 810 during operation. The flex assembly 830 includes a printed circuit board 834 to which a flex cable connected with the actuator assembly 810 and leading to the head 818 is connected. The flex cable may be routed along the actuator arms 814 and the flexures 816 to the transducer heads 818. The printed circuit board 834 typically includes circuitry for controlling the write currents applied to the transducer heads 818 during a write operation and a preamplifier for amplifying read signals generated by the transducer heads 818 during a read operation. The flex assembly 830 terminates at a flex bracket for communication through the base deck 802 to a disc drive printed circuit board (not shown) mounted to the bottom side of the disc drive 800.

In one implementation, transducer head 818 includes multiple read sensors placed up track of the write pole. In another implementation, transducer head 818 includes multiple read sensors placed up track of the write pole, and the read sensors are separated by reader shields. In yet another implementation, transducer head 818 includes at least one read sensor placed up track of the write pole and at least one read sensor placed down track of the write pole.

The disc drive 800 also includes a read sensor according to the implementations disclosed herein. The read sensor 836 located on the transducer head 818 wherein the read sensor 836 includes a read sensor structure having an synthetic anti-ferromagnetic (SAF) structure with a pinning that is canted with respect to an air bearing surface (ABS) of the read sensor. In an implementation of the read sensor, the angle between the magnetization direction of a reference layer (RL) and the magnetization direction of a free layer (FL) is obtuse.

The above specification, examples, and data provide a complete description of the structure and use of example implementations of the invention. Since many implementations of the invention can be made without departing from the spirit and scope of the invention, the invention resides in the claims hereinafter appended. Furthermore, structural features of the different implementations may be combined in yet another implementation without departing from the recited claims. The implementations described above and other implementations are within the scope of the following claims.

1. An apparatus comprising:
a read sensor having a reference layer (RL) with a magnetic moment direction canted in comparison to direction of a magnetic moment of a free layer (FL) at an angle other than 90 degrees, wherein the magnetic moment direction of the RL and the magnetic moment of the FL rotate in opposite directions during a change in magnetic field from a medium.

2. The apparatus of claim 1 wherein an angle between the magnetic moment direction of the RL and the direction of the magnetic moment of the FL is obtuse.

3. The apparatus of claim 1 wherein an angle between the magnetic moment pinning direction of the RL and the direction of the magnetic moment of the FL is greater than 105 degrees.

4. (canceled)

5. The apparatus of claim 1 wherein the read sensor is located on a transducer head of a disc drive.

6. The apparatus of claim 1 wherein an asymmetry of the read sensor depends on an angle between the magnetic moment pinning direction of the RL and an air-bearing surface (ABS) of the read sensor.

7. The apparatus of claim 1 wherein amplitude of a resistance-based signal generated by the read sensor depends on an angle between the magnetic moment direction of the RL and an air-bearing surface (ABS) of the read sensor.

8. The apparatus of claim 1 wherein the FL is made of a high moment material including one of (a) CoFe and (b) CoFeNi.

9. (canceled)

10. (canceled)

11. (canceled)

12. (canceled)

13. (canceled)

14. (canceled)

15. (canceled)

16. (canceled)

17. (canceled)

18. (canceled)

19. An apparatus comprising:
a read sensor having the free layer (FL) and a synthetic antiferromagnetic structure (SAF) including a reference layer (RL) and a pinned layer (PL), wherein the magnetic moment of at least one of the RL and the PL is canted in comparison to direction of a magnetic moment of the free layer (FL) at an angle other than 90 degrees, and wherein the magnetic moment direction of the RL and the magnetic moment of the FL rotate in opposite directions during a change in magnetic field from a medium.

20. The apparatus of claim 19, wherein an angle between the magnetic moment direction of the RL and the direction of the magnetic moment of the FL is obtuse.

21. The apparatus of claim 19, wherein the magnetic moment of the PL is canted with respect to an air-bearing surface (ABS) of the read sensor by an angle other than 90 degrees.

22. The apparatus of claim 19, wherein the magnetic moment of the RL is canted with respect to an air-bearing surface (ABS) of the read sensor by an angle other than 90 degrees.

23. The apparatus of claim 22, wherein the read sensor is located on a transducer head of a disc drive.

24. The apparatus of claim 22, wherein as the angle between the magnetic moment of the RL and the ABS increases from −90 to −40, amplitude of a resistance-based signal generated by the read sensor increases.

25. The apparatus of claim 22, wherein as the angle between the magnetic moment of the RL and the ABS increases from −90 to −40, an asymmetry of the read sensor decreases.

26. A storage device, comprising:
a magnetic storage media; and
a read sensor having an air-bearing surface (ABS) with respect to the storage media, the read sensor comprising a reference layer (RL) and a pinning layer (PL) separated by a Ruthenium (Ru) layer, and a free layer (FL), wherein a magnetic moment direction of the RL is canted in comparison to direction of a magnetic moment of a free layer (FL) at an angle other than 90 degrees and wherein the magnetic moment of the FL rotate in opposite directions during a change in magnetic field from a medium.

27. The storage device of claim 26, wherein the angle between the magnetic moment direction of the RL and the direction of the magnetic moment of the FL is obtuse.

28. The storage device of claim 26, wherein an angle between the magnetic moment pinning direction of the RL and the direction of the magnetic moment of the FL is greater than 105 degrees.

29. (canceled)
